(19) United States
(12) Patent Application Publication
(10) Pub. No.: US 2020/0274184 A1
(43) Pub. Date: Aug. 27, 2020

(54) CONTACT PLATE ARRANGEMENT WITH THREE OR MORE CONTACT PLATE LAYERS

(71) Applicant: TIVENI MERGECO, INC., San Mateo, CA (US)

(72) Inventors: Alexander EICHHORN, Eppingen (DE); Heiner FEES, Bietigheim-Bissingen (DE); Andreas TRACK, Sachsenheim (DE); Ralf MAISCH, Abstatt (DE); Jörg DAMASKE, Freiberg (DE); Valentin BROKOP, Walheim (DE); Hans-Joachim PFLÜGER, Wüstenrot (DE); Claus Gerald PFLÜGER, Markgröningen (DE)

(21) Appl. No.: 16/800,814

(22) Filed: Feb. 25, 2020

Related U.S. Application Data
(60) Provisional application No. 62/810,774, filed on Feb. 26, 2019.

(51) Int. Cl. H01M 10/04; H01M 2/10; H01M 10/0585; B60L 50/64

(52) U.S. Cl. CPC H01M 10/0413; H01M 2/1077; H01M 2220/20; B60L 50/64; H01M 10/0585

(57) ABSTRACT

An aspect is directed to a contact plate arrangement for a battery module. The contact plate arrangement comprises a first contact plate connected to first terminals of a first parallel group of battery cells (P-Group) and to second terminals of a second P-Group, a second contact plate that is partially stacked over the first contact plate, the second contact plate connected to first terminals of the second P-Group and to second terminals of a third P-Group, and a third contact plate that is partially stacked over the second contact plate, the third contact plate connected to first terminals of the third P-Group.

### CROSS-REFERENCE TO RELATED APPLICATIONS

The present Application for Patent claims the benefit of U.S. Provisional Application No. 62/810,774 with attorney docket no. TIV-180010P1, entitled “CONTACT PLATE ARRANGEMENT WITH THREE OR MORE CONTACT PLATE LAYERS”, filed Feb. 26, 2019, which is assigned to the assignee hereof and hereby expressly incorporated by reference herein in its entirety.

### BACKGROUND

### 1. Field of the Disclosure

Embodiments relate to contact plate arrangements, and more particularly, to contact plate arrangements comprising three or more contact plate layers.

### 2. Description of the Related Art

Energy storage systems may rely upon battery cells for storage of electrical power. For example, in certain conventional electric vehicle (EV) designs (e.g., fully electric vehicles, hybrid electric vehicles, etc.), a battery housing mounted into an electric vehicle houses a plurality of battery cells (e.g., which may be individually mounted into the battery housing, or alternatively may be grouped within respective battery modules that each contain a set of battery cells, with the respective battery modules being mounted into the battery housing). The battery modules in the battery housing are connected to a battery junction box (BJB) via busbars, which distribute electric power to an electric motor that drives the electric vehicle, as well as various other electrical components of the electric vehicle (e.g., a radio, a control console, a vehicle Heating, Ventilation and Air Conditioning (HVAC) system, internal lights, external lights such as head lights and brake lights, etc.).

### SUMMARY

An embodiment is directed to a contact plate arrangement for a battery module, comprising a first contact plate connected to first terminals of a first parallel group of battery cells (P-Group) and to second terminals of a second P-Group, a second contact plate that is partially stacked over the first contact plate, the second contact plate connected to first terminals of the second P-Group and to second terminals of a third P-Group, and a third contact plate that is partially stacked over the second contact plate, the third contact plate connected to first terminals of the third P-Group.

### BRIEF DESCRIPTION OF THE DRAWINGS

A more complete appreciation of embodiments of the disclosure will be readily obtained as the same becomes better understood by reference to the following detailed description when considered in connection with the accompanying drawings, which are presented solely for illustration and not limitation of the disclosure, and in which:

FIG. 1 illustrates an example metal-ion (e.g., Li-ion) battery in which the components, materials, methods, and other techniques described herein, or combinations thereof, may be applied according to various embodiments.

FIG. 2 illustrates a high-level electrical diagram of a battery module that shows P groups 1 . . . N connected in series in accordance with an embodiment of the disclosure.

FIG. 3 illustrates a battery module during assembly after battery cells are inserted therein.

FIGS. 4A-4C illustrate the general arrangement of contact plate(s) with respect to battery cells of a battery module.

FIG. 5 illustrates an example of the layers of a conventional multi-layer contact plate.

FIG. 6 illustrates a contact plate arrangement for a battery module in accordance with an embodiment of the disclosure.

FIG. 7 illustrates a battery module that comprises the contact plate arrangement of FIG. 6.

FIG. 8 illustrates a contact plate arrangement for a battery module in accordance with an embodiment of the disclosure.

FIG. 9 illustrates the flow of current across the respective contact plates of contact plate arrangement of FIG. 8.

FIG. 10 illustrates a battery module that comprises the contact plate arrangement of FIG. 8.

FIGS. 11-12 illustrate exploded and top perspectives of a contact arrangement in accordance with another embodiment of the disclosure.

FIG. 13 illustrates respective layers being constructed (from bottom to top) so as to create the layered or “stacked” structure of the contact arrangement of FIG. 11 in accordance with an embodiment of the disclosure.

FIG. 14 illustrates a top perspective of the contact plate arrangement of FIG. 11 in a connected state to P-Groups 1 . . . 6 in accordance with an embodiment of the present disclosure.

FIG. 15A illustrates a zoomed perspective of the contact plate arrangement in the connected state as shown in FIG. 14, with the current flow across particular cells from P-Group 1 to P-Group 6 being indicated with arrows in accordance with an embodiment of the disclosure.

FIG. 15B illustrates an alternative representation of the current flow depicted in FIG. 15A.

FIG. 15C illustrates representation of a current flow that is reversed from the current flow depicted in FIG. 15A in accordance with an alternative embodiment of the disclosure.

### DETAILED DESCRIPTION

Embodiments of the disclosure are provided in the following description and related drawings. Alternate embodiments may be devised without departing from the scope of the disclosure. Additionally, well-known elements of the disclosure will not be described in detail or will be omitted so as not to obscure the relevant details of the disclosure.

Energy storage systems may rely upon batteries for storage of electrical power. For example, in certain conventional electric vehicle (EV) designs (e.g., fully electric vehicles, hybrid electric vehicles, etc.), a battery housing mounted into an electric vehicle houses a plurality of battery cells (e.g., which may be individually mounted into the battery housing, or alternatively may be grouped within respective battery modules that each contain a set of battery cells, with the respective battery modules being mounted into the battery housing). The battery modules in the battery housing are connected to a battery junction box (BJB) via busbars, which distribute electric power to an electric motor that drives the electric vehicle, as well as various other electrical components of the electric vehicle (e.g., a radio, a control console, a vehicle Heating, Ventilation and Air Conditioning (HVAC) system, internal lights, external lights such as head lights and brake lights, etc.).

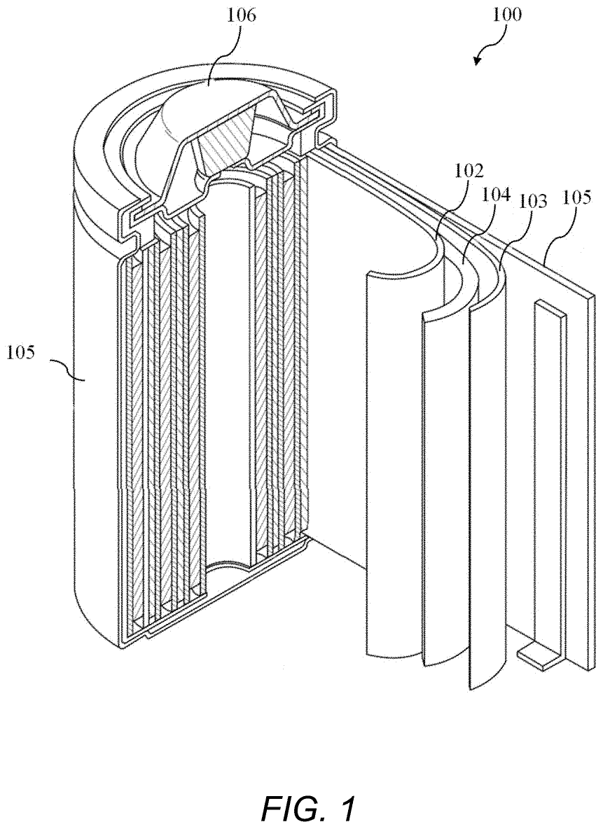

FIG. 1 illustrates an example metal-ion (e.g., Li-ion) battery in which the components, materials, methods, and other techniques described herein, or combinations thereof, may be applied according to various embodiments. A cylindrical battery cell is shown here for illustration purposes, but other types of arrangements, including prismatic or pouch (laminate-type) batteries, may also be used as desired. The example battery 100 includes a negative anode 102, a positive cathode 103, a separator 104 interposed between the anode 102 and the cathode 103, an electrolyte (shown implicitly) impregnating the separator 104, a battery case 105, and a sealing member 106 sealing the battery case 105.

Embodiments of the disclosure relate to various configurations of battery modules that may be deployed as part of an energy storage system. In an example, while not illustrated expressly, multiple battery modules in accordance with any of the embodiments described herein may be deployed with respect to an energy storage system (e.g., chained in series to provide higher voltage to the energy storage system, connected in parallel to provide higher current to the energy storage system, or a combination thereof).

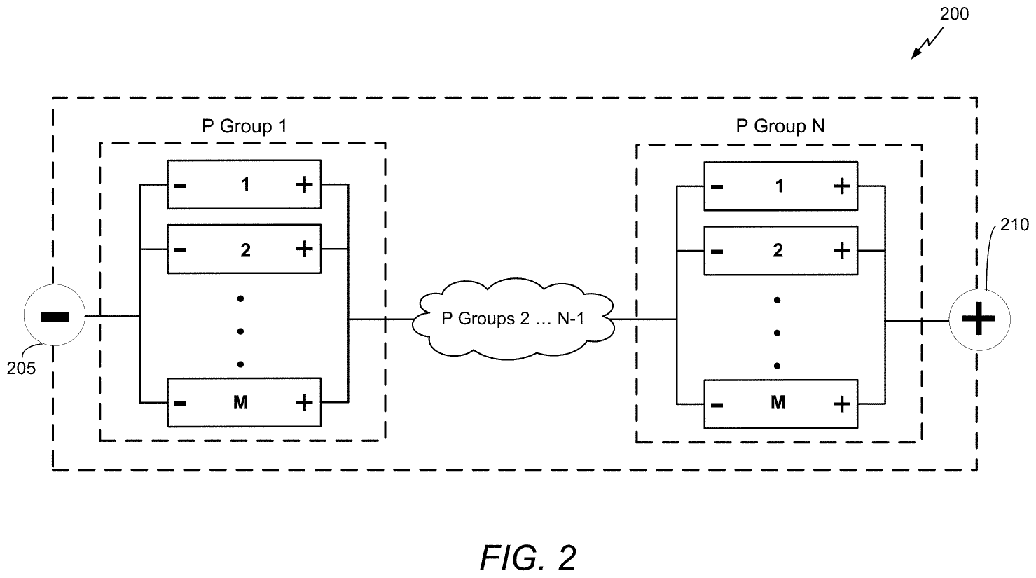

FIG. 2 illustrates a high-level electrical diagram of a battery module 200 that shows P groups 1 . . . N connected in series in accordance with an embodiment of the disclosure. In an example, N may be an integer greater than or equal to 2 (e.g., if N=2, then the intervening P groups denoted as P groups 2 . . . N−1 in FIG. 1 may be omitted). Each P group includes battery cells 1 . . . M (e.g., each configured as shown with respect to battery cell 100 of FIG. 1) connected in parallel. The negative terminal of the first series-connected P group (or P group 1) is coupled to a negative terminal 205 of the battery module 200, while the positive terminal of the last series-connected P group (or P group N) is connected to a positive terminal 210 of the battery module 200. As used herein, battery modules may be characterized by the number of P groups connected in series included therein. In particular, a battery module with 2 series-connected P groups is referred to as a “2S” system, a battery module with 3 series-connected P groups is referred to as a “3S” system, and so on.

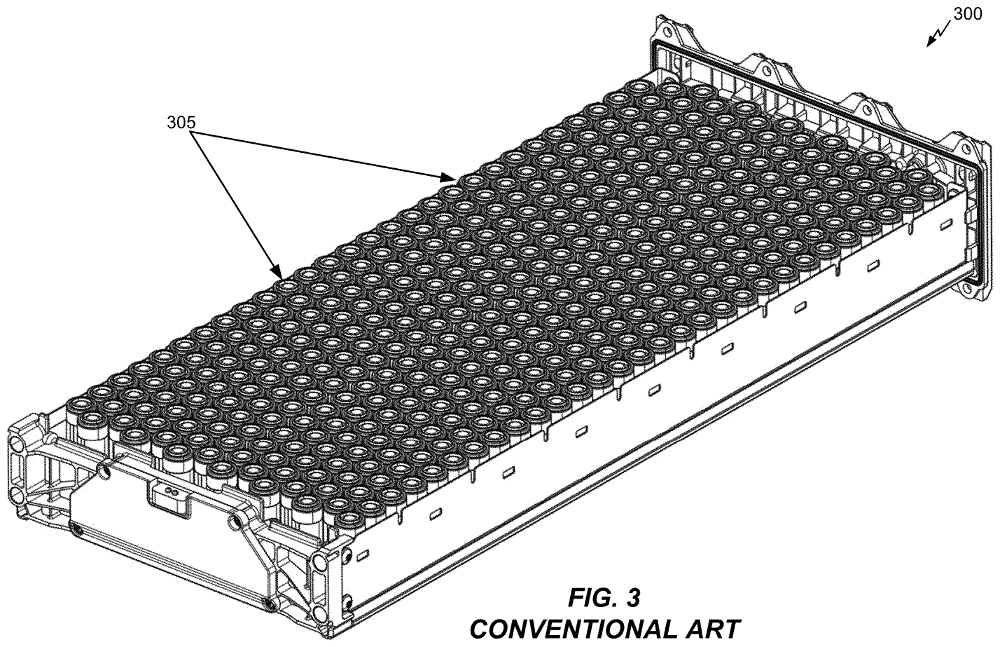

FIG. 3 illustrates a battery module 300 during assembly after battery cells 305 are inserted therein. In some designs, both the positive terminal (cathode) and negative terminal (anode) of the battery cells in the battery module 300 may be arranged on the same side (e.g., the top side). For example, the centered cell ‘head’ may correspond to the positive terminal, while the outer cell rim that rings the cell head may correspond to the negative terminal. In such a battery module, the P groups are electrically connected in series with each other via a plurality of contact plates arranged on top of the battery cells 305.

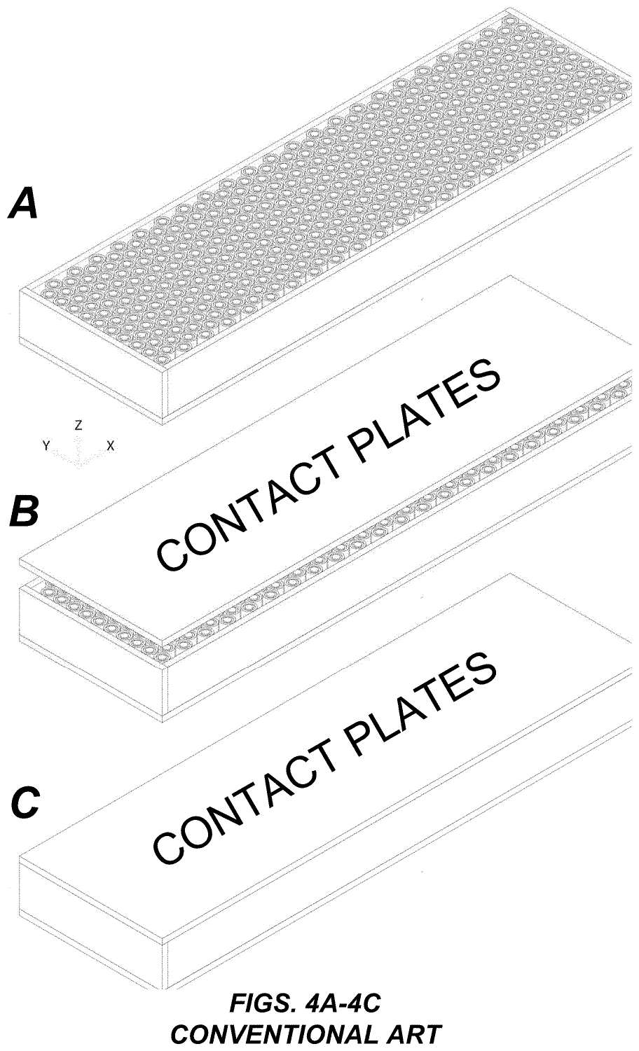

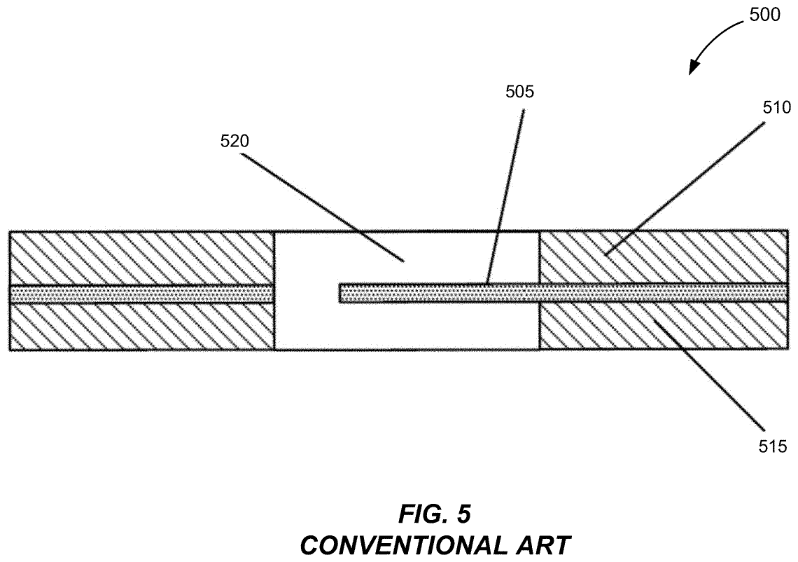

FIGS. 4A-4C illustrate the general arrangement of contact plate(s) with respect to battery cells of a battery module. As shown in FIGS. 4A-4C, the contact plates may be arranged on top of the battery cells in close proximity to their respective positive and negative terminals in some designs.

There are a variety of ways in which the above-noted contact plates may be configured. For example, the contact plates can be configured as solid blocks of aluminum or copper, whereby bonding connectors are spot-welded between the contact plates and the positive and negative terminals of the battery cells. Alternatively, a multi-layer contact plate that includes an integrated cell terminal connection layer may be used.

FIG. 5 illustrates an example of the layers of a conventional multi-layer contact plate 500. In FIG. 5, the multi-layer contact plate 500 includes a flexible cell terminal connection layer 505 that is sandwiched between a top conductive plate 510 and a bottom conductive plate 515. In an example, the top and bottom conductive plates 510 and 515 may be configured as solid Cu or Al plates (e.g., or an alloy of Cu or Al), while the flexible cell terminal connection layer 505 is configured as foil (e.g., steel or Hilumin foil). A number of openings, such as opening 520, are punched into the top and bottom conductive plates 510 and 515, while some part of the flexible cell terminal connection layer 505 extends out into the opening 520. During battery module assembly, the part of the flexible cell terminal connection layer 505 that extends into the opening 520 can then be pressed downward so as to contact a positive or negative terminal of one or more battery cells arranged underneath the opening 520, and then welded to obtain a mechanically stable plate-to-terminal electrical connection.

Referring to FIG. 5, the layers of the multi-layer contact plate 500 may be joined via soldering or brazing (e.g., based on soldering or brazing paste being arranged between the respective layers before heat is applied), which results in soldering or brazing “joints” between the respective layers. These joints provide both (i) an inter-layer mechanical connection for the multi-layer contact plate 500, and (ii) an inter-layer electrical connection for the multi-layer contact plate 500.

Referring to FIG. 5, one of the advantages of configuring the flexible cell terminal connection layer 505 with a different material (e.g., steel or Hilumin) than the surrounding top and bottom conductive plates 510 and 515 (e.g., Cu, Al, or an alloy thereof) is so that the cell terminal connections can be welded via like metals. For example, it is common for cell terminals to be made from steel or Hilumin. However, steel is not a particularly good conductor. Hence, the top and bottom conductive plates 510 and 515 are made from a more conductive material (e.g., Cu, Al, or an alloy thereof) than steel, while steel is used in the flexible cell terminal connection layer 505 to avoid disparate metals being welded together for the cell terminal connection.

In an alternative embodiment to the contact plate configuration depicted in FIG. 5, instead of two solid plates sandwiching a foil terminal connection layer, a contact plate (e.g., Cu, Al, or an alloy thereof, although it is possible for the contact plate to be multi-layer) can be coated with a thin layer of a different metal (e.g., steel or Hilumin) that is suitable to be welded to one or more battery cell terminals. The coated contact plate can be locally punched or etched to define specific sections that (i) can be moved flexibly, or (ii) can be configured as a fuse, or (iii) can be made suitable for welding to the battery cell terminal(s).

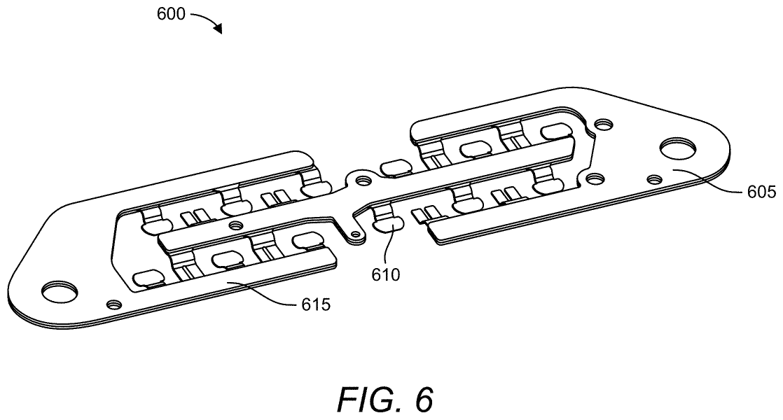

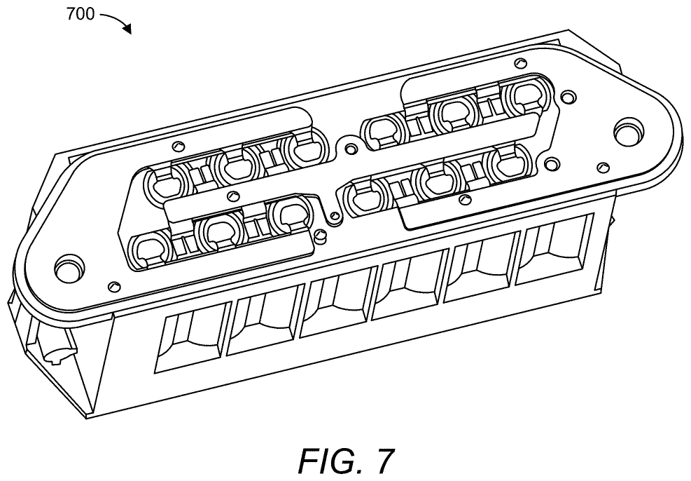

FIG. 6 illustrates a contact plate arrangement 600 for a battery module in accordance with an embodiment of the disclosure. The contact plate arrangement 600 is configured with single-layer contact plate configuration. As used herein, contact plates being arranged in a single-layer means that the contact plates do not overlap (or stack) with each other, and thereby do not require ‘vertical’ electrical insulation layers (although insulation may be arranged to provide ‘horizontal’ electrical insulation). In particular, the contact plate arrangement 600 includes a “negative pole” contact plate 605, a “center” contact plate 610, and a “positive pole” contact plate 615. The contact plate arrangement 600 is configured to chain two distinct P-Groups (i.e., distinct parallel groups of battery cells as described above with respect to FIG. 2) together in series. To this end, the “negative pole” contact plate 605 includes a set of negative bonding connectors for connecting to a set of negative cell terminals of P-Group 1, the “center” contact plate 610 includes a set of positive bonding connectors for connecting to a set of positive cell terminals of P-Group 1 as well as a set of negative bonding connectors for connecting to a set of negative cell terminals of P-Group 2, and the “positive pole” contact plate 615 includes a set of positive bonding connectors for connecting to a set of positive cell terminals of P-Group 2. FIG. 7 illustrates a battery module 700 that comprises the contact plate arrangement 600 of FIG. 6.

In the embodiment of FIGS. 6-7, the contact plate arrangement 600 connects a total of 12 battery cells together, with 6 battery cells per P-Group. In an example, the contact plates 605-615 may be arranged as multi-layer contact plates (e.g., top/bottom plates made from Aluminum sandwiching a steel layer (Hilumin), with each multi-layer contact plate having a total average thickness of about 1.8 mm).

Embodiments of the present disclosure are directed to contact plate arrangements with three or more contact plate layers. By using additional contact plate layers, the number of battery cells in each P-Group can be reduced relative to the contact plate arrangement 600, and the overall thickness of each contact plate can also be reduced relative to the contact plate arrangement 600. Moreover, in some designs, such contact plates may be produced without soldering/brazing.

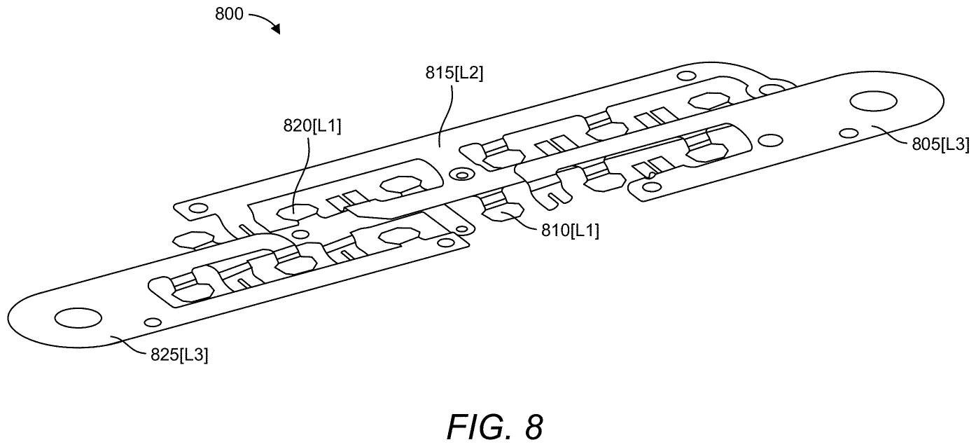

FIG. 8 illustrates a contact plate arrangement 800 for a battery module in accordance with an embodiment of the disclosure. The contact plate arrangement 800 is configured with three-layer contact plate configuration. In particular, the contact plate arrangement 800 includes a “negative pole” contact plate 805[L3], center contact plates 810[L1], 815[L2] and 820[L1], and “positive pole” contact plate 825[L3], whereby L1 denotes contact plate layer 1, L2 denotes contact plate layer 2, and L3 denotes contact plate layer 3.

As shown in FIG. 8, a respective contact plate may be ‘partially’ stacked (e.g., arranged over in vertical of Z direction) over contact plate(s) of lower contact plate layer(s) with part of the respective contact plate (in an overlapped area) being arranged over the contact plate(s) of the lower contact plate layer(s). As used herein, a ‘higher’ contact plate layer may generally be characterized as further away from the cell terminals to which the respective contact plates are connected, and a ‘lower’ contact plate layer may generally be characterized as further away from the cell terminals to which the respective contact plates are connected. In some designs, in non-overlapping areas, a contact plate in a higher layer may dip to or below the ‘height’ of a contact plate in a lower. Also, some contact plate components (e.g., bonding connectors) may extend downwards beneath contact plate(s) in lower layers.

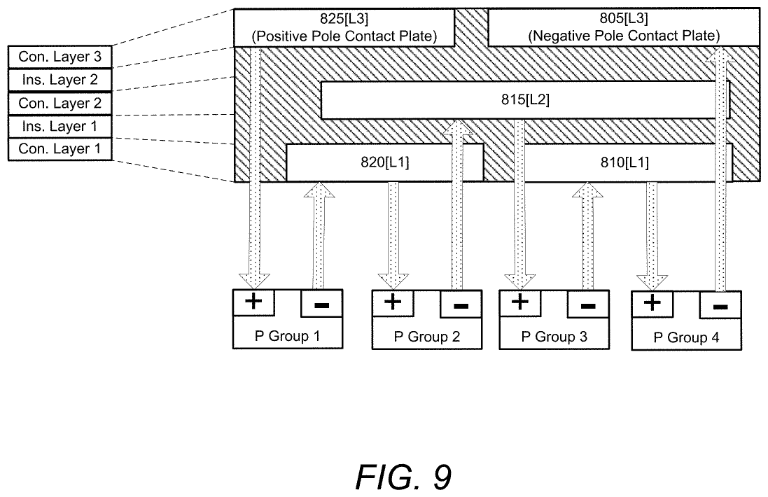

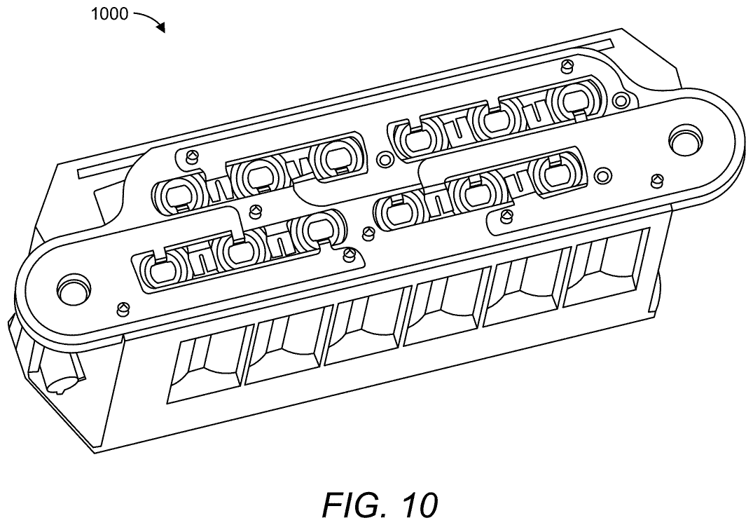

The flow of current across the respective contact plates of contact plate arrangement 800 of FIG. 8 is depicted in FIG. 9. FIG. 10 illustrates a battery module 800 that comprises the contact plate arrangement 800 of FIG. 8.

In the embodiment of FIG. 8, the contact plate arrangement 800 connects a total of 12 battery cells together, with 3 battery cells per P-Group (i.e., P-Groups 1, 2, 3 and 4). In other designs, a different number of battery cells per P-Group may be implemented (e.g., 4 battery cells per P-Group, 5 battery cells per P-Group, etc.). In some designs, each contact plate of the contact plate arrangement 800 may be made thinner (on average) relative to the contact plates of the contact plate arrangement 600 (on average). For example, the contact plate arrangement 600 may be arranged with multi-layer contact plates (e.g., top/bottom plates made from Aluminum sandwiching an steel of Hilumin layer, with each multi-layer contact plate having a total average thickness of about 1.8 mm), whereas the contact plate arrangement 800 may be arranged with thinner contact plates (e.g., single plates of Steel (Hilumin) or Aluminum or Copper or a sandwich out of these layers). As will be explained below in more detail, in some designs, the use of three thinner contact plate layers instead of one thick contact plate layer can reduce the overall thickness of the contact plate arrangement.

As will be appreciated, chaining more P-Groups together in series functions to increase the voltage of an associated battery module. So, while FIGS. 8-10 are directed to a battery module that includes four P-Groups (with three cells per P-Group), additional P-Groups may be added for higher voltage applications.

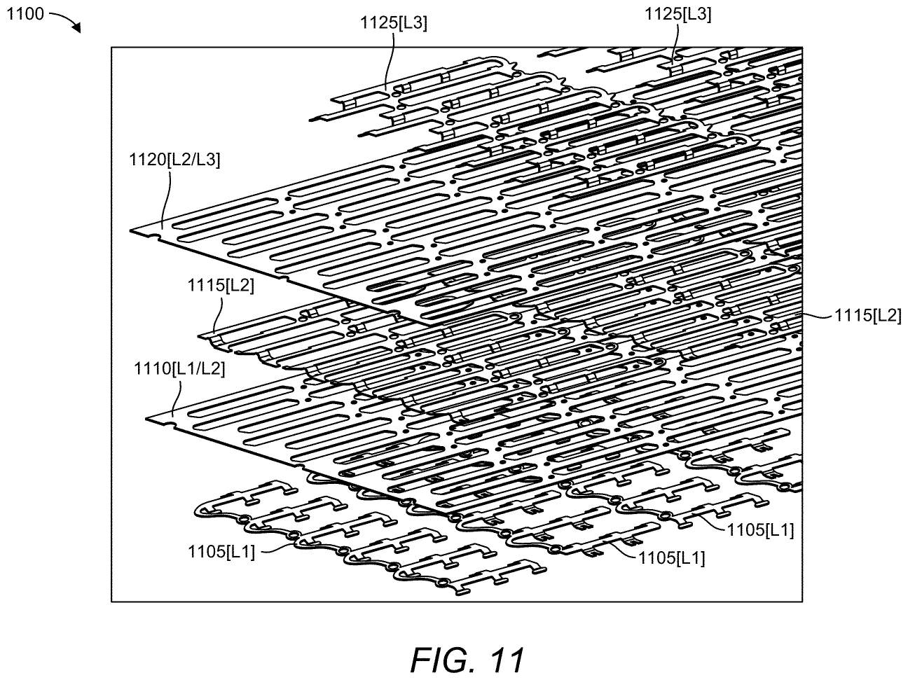

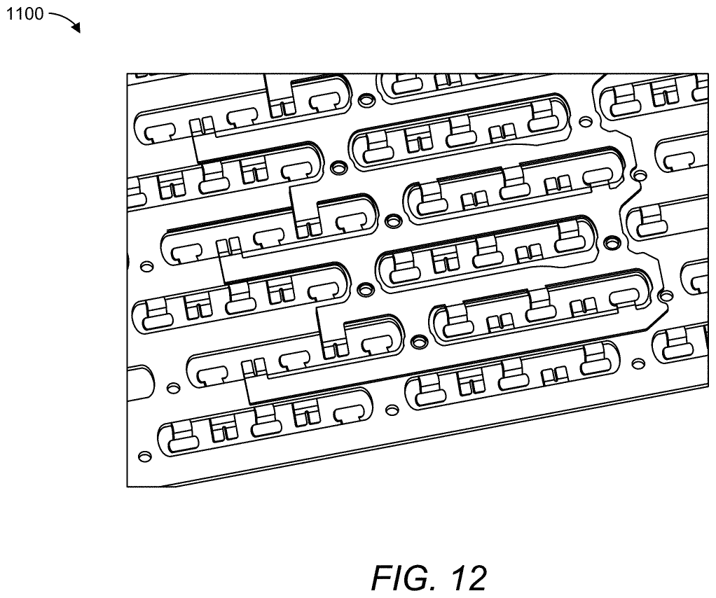

FIGS. 11-12 illustrate exploded and top perspectives of a contact arrangement 1100 in accordance with another embodiment of the disclosure. Referring to FIGS. 11-12, the contact arrangement 1100 includes a bottom contact plate layer (or “layer 1”) that includes a plurality of contact plates 1105[L1], a middle contact plate layer (or “layer 2”) that includes a plurality of contact plates 1115[L2], and a top contact plate layer (or “layer 3”) that includes a plurality of contact plates 1125[L3]. Both the number of contact plates per contact plate layer and the number of “fingers” per contact plate are scalable to accommodate any number of P-Groups and/or P-Groups of different sizes. Hence, the basic three-layer architecture may scale to particular battery module configurations.

The contact arrangement 1100 further includes a first insulation layer 1110[L1/L2] arranged between the first and second layers, and a second insulation layer 1120[L2/L3] arranged between the second and third layers. The respective insulation layer may be made from any suitable electrically insulative material (e.g., plastic, etc.).

As shown in FIG. 12, when the respective layers of the contact arrangement 1100 are stacked together, contact tabs from each contact plate layer extend into openings (or contact areas) arranged in the respective layers so as to form electrical connections with corresponding terminals of battery cells arranged underneath the contact arrangement 1100 during battery module assembly.

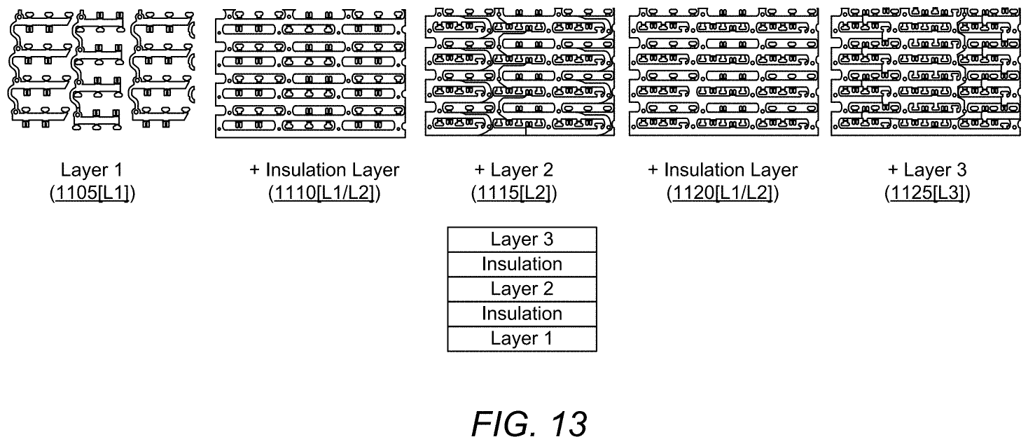

FIG. 13 illustrates the respective layers being constructed (from bottom to top) so as to create the layered or “stacked” structure of the contact arrangement 1100 in accordance with an embodiment of the disclosure.

As noted above, under certain design assumptions, the contact plate arrangement 600 of FIG. 6 may be constructed with a total average thickness of approximately 1.8 mm. Under the same design assumptions (e.g., same type of cylindrical battery cells, etc.), the average thickness of each contact plate layer may be approximately 0.15 mm and the average thickness of each insulation layer may be approximately 0.3 mm, such that the contact plate arrangements 800 and 1100 may be constructed with a total average thickness of approximately 1.05 mm (0.15 mm+0.3 mm+0.15 mm+0.3 mm+0.15 mm=1.05 mm). Alternatively, if additional top/bottom layers of insulation are added at 0.15 mm thickness each, the total thickness becomes 1.35 mm. In either case, increasing the number of P-Groups while reducing the number of cells per P-Group permits each contact plate to be thinner (on average), which functions to reduce the overall thickness of the contact plate arrangement (e.g., from about 1.8 mm in FIG. 6 to about 1.05 mm or about 1.35 mm depending on operational assumptions as noted above). In some designs, the contact plate layers may have a thickness in the range from about 0.15 mm to about 0.2 mm, depending on the battery module design and associated power requirements.

Further, while some designs may use a “sandwich” contact plate structure that comprises two plates that sandwich a thinner foil layer, the thinner contact plate structure described with respect to the contact arrangement 8 of FIGS. 8-10 may be comprised of a single electrically conductive layer (e.g., a single plate) in some designs. In this case, no inter-layer soldering or brazing need be performed as may be required to facilitate a sandwich structure, which results in a contact plate with higher structural integrity and electrical conductivity.

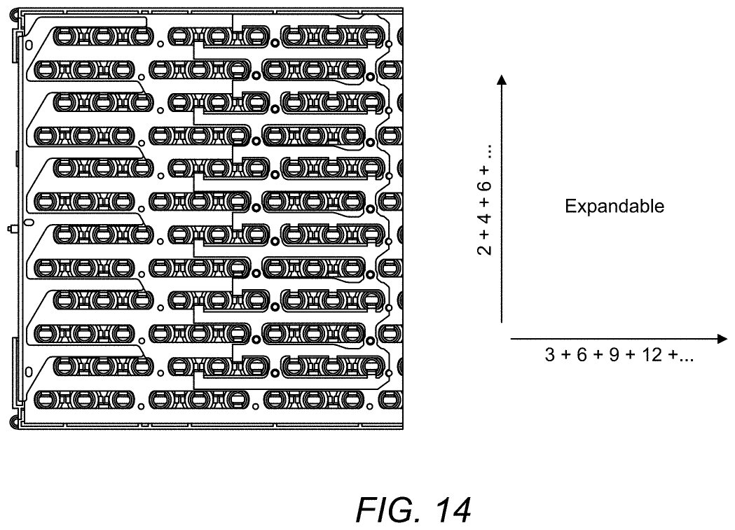

FIG. 14 illustrates a top perspective of the contact plate arrangement 1100 in a connected state to P-Groups 1 . . . 6 in accordance with an embodiment of the present disclosure. As shown in FIG. 14, the contact plate arrangement 1100 is expandable (or scalable) either with respect to the number of “fingers” per contact plate and/or in terms of the number of contact plates per contact plate layer to accommodate various battery module configurations. In the particular part of the contact plate arrangement 1100 shown in FIG. 14, P-Groups 1 . . . 6 are connected together in series (i.e., P-Group 1 is connected in series to P-Group 2, which is in turn connected in series to P-Group 3, and so on). In this example, the positive side of P-Group 1 is connected to the “positive pole” contact plate (e.g., which may function as a positive terminal of the battery module itself). Also, while not shown explicitly in FIG. 14, P-Group 6 may be connected in series to yet another P-Group, and so on.

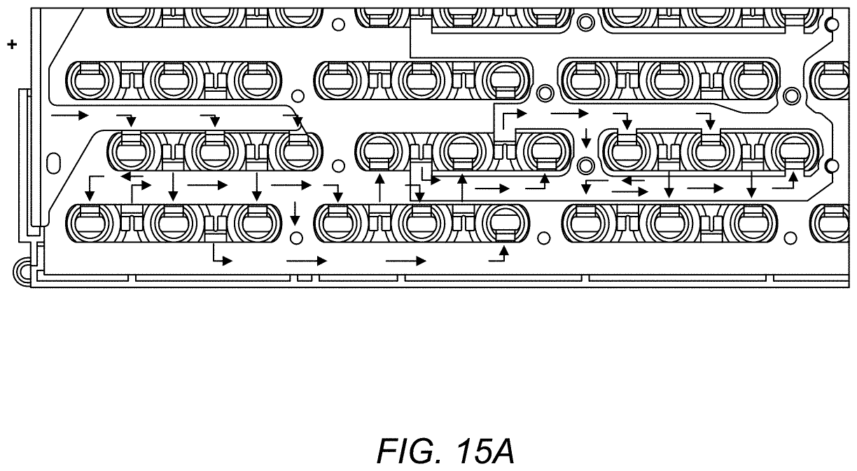

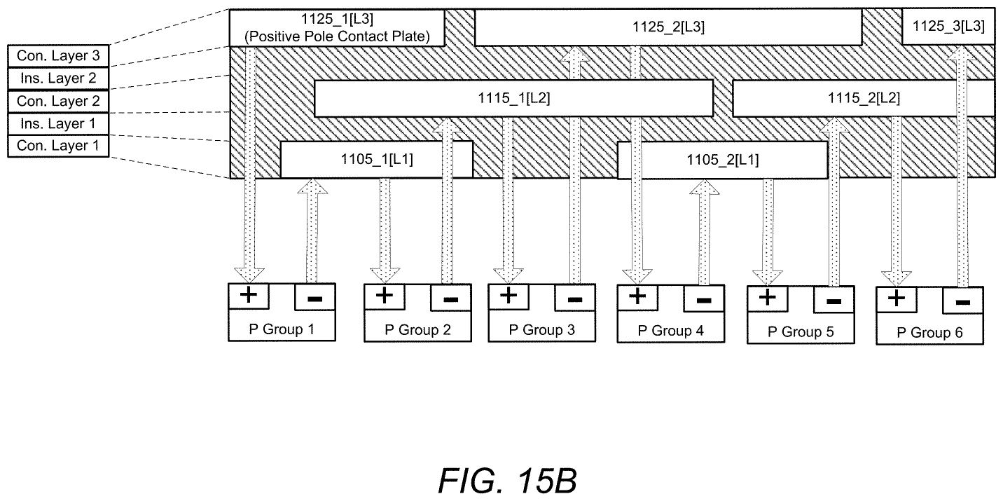

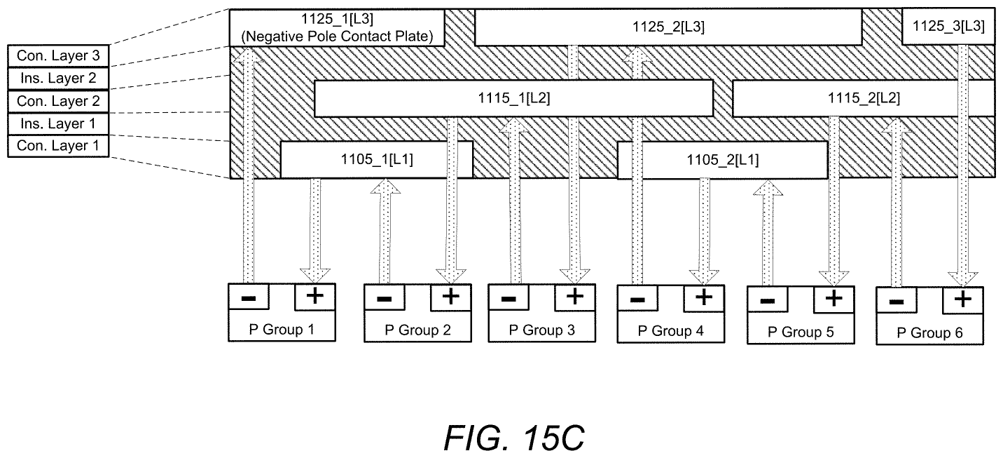

FIG. 15A illustrates a zoomed perspective of the contact plate arrangement 1100 in the connected state as shown in FIG. 14, with the current flow across particular cells from P-Group 1 to P-Group 6 being indicated with arrows in accordance with an embodiment of the disclosure. FIG. 15B illustrates an alternative representation of the current flow depicted in FIG. 15A.

Referring to FIG. 15B, a positive pole contract plate 1125_1[L3] is partially stacked over contact plate 1105_1[L1], and is connected to positive terminals of P-Group 1. Contact plate 1105_1[L1] is connected to negative terminals of P-Group 1, and to positive terminals of P-Group 2. Contact plate 1115_1[L2] is partially stacked over contact plate 1105_1[L1], and is connected to negative terminals of P-Group 2, and to positive terminals of P-Group 3. Contact plate 1125_2[L3] is partially stacked over contact plate 1115_1[L2], and is connected to negative terminals of P-Group 3, and to positive terminals of P-Group 4. Contact plate 1105_2[L1] is connected to negative terminals of P-Group 4, and to positive terminals of P-Group 5. Contact plate 1115_2[L2] is partially stacked over contact plate 1105_2[L1], and is connected to negative terminals of P-Group 5, and to positive terminals of P-Group 6. Contact plate 1125_3[L3] is partially stacked over contact plate 1115_2[L2], and is connected at least to negative terminals of P-Group 6. In an example, contact plate 1125_3[L3] may be arranged as a negative pole contact plate for the battery module. In an alternative example, contact plate 1125_3[L3] may be yet another ‘center’ contact plate, in which case the contact plate 1125_3 [L3] would further be connected to positive terminals of P-Group 7 (not shown in FIG. 15B). So, contact plates connected P-Groups in series via layers L1, L2, L3, L1, L2, L3, etc. are reflected the embodiment of FIG. 15B.

In other embodiments, adjacent series-connected P-Groups may be connected to respective contact plate layers in different sequences (e.g., L3-L2-L1-L3-L2-L1, etc.). This aspect is reflected in FIG. 15C. In FIG. 15C, the polarity and current flow across P-Groups 1-6 is reversed, such that current flows from P-Group 6 to P-Group 5, and so on, in series. The contact plate 1125_1[L3] thereby becomes the positive pole contact plate in FIG. 15C, instead of the negative pole contact plate. As will be appreciated, the sequence of layer changes between adjacent P-Groups (e.g., electrically adjacent in terms of the in-series connections whereby P-Group 1 is adjacent to P-Group 2, P-Group 2 is adjacent to P-Groups 1 and 3, and so on) can vary based on the implementation.

In other embodiments, the positive pole and/or negative pole contact plates can be arranged at other layers (e.g., L2 or L1) as opposed to the L3 layer. In other designs, additional layers (e.g., L4, L5, etc.) may be added, and the various layer changes between adjacent P-Groups can correspond to any possible sequence (e.g., L1-L2-L3-L5-L4, L1-L3-L5-L2-L4, etc.) and likewise the positive/negative pole contact plates can be arranged at any layer (e.g., L1, L2, L3, L4, L5, etc.).

As noted above, the layered contact plate structure (for a three-layer contact plate arrangement) may be characterized in terms of first, second and third contact plate layers, whereby multiple contact plates may belong to each respective contact plate layer. Generally, a so-called ‘top’ contact plate layer may comprise contact plates that are partially stacked (i.e., overlapped in vertical direction) over contact plates among the bottom and/or middle contact plate layers. The middle contact plate layer may be likewise partially stacked over the bottom contact plate layer. Holes or gaps may be defined that permit respective contact tabs from each respective contact plate layer among the middle and/or top contact plate layers to extend downwards so as to form welded connections to the battery cell terminals of respective P-Groups.

Any numerical range described herein with respect to any embodiment of the present invention is intended not only to define the upper and lower bounds of the associated numerical range, but also as an implicit disclosure of each discrete value within that range in units or increments that are consistent with the level of precision by which the upper and lower bounds are characterized. For example, a numerical distance range from 7 nm to 20 nm (i.e., a level of precision in units or increments of ones) encompasses (in nm) a set of [7, 8, 9, 10, . . . , 19, 20], as if the intervening numbers 8 through 19 in units or increments of ones were expressly disclosed. In another example, a numerical percentage range from 30.92% to 47.44% (i.e., a level of precision in units or increments of hundredths) encompasses (in %) a set of [30.92, 30.93, 30.94, . . . , 47.43, 47.44], as if the intervening numbers between 30.92 and 47.44 in units or increments of hundredths were expressly disclosed. Hence, any of the intervening numbers encompassed by any disclosed numerical range are intended to be interpreted as if those intervening numbers had been disclosed expressly, and any such intervening number may thereby constitute its own upper and/or lower bound of a sub-range that falls inside of the broader range. Each sub-range (e.g., each range that includes at least one intervening number from the broader range as an upper and/or lower bound) is thereby intended to be interpreted as being implicitly disclosed by virtue of the express disclosure of the broader range.

The forgoing description is provided to enable any person skilled in the art to make or use embodiments of the invention. It will be appreciated, however, that the invention is not limited to the particular formulations, process steps, and materials disclosed herein, as various modifications to these embodiments will be readily apparent to those skilled in the art. That is, the generic principles defined herein may be applied to other embodiments without departing from the spirit or scope of the embodiments of the invention.

What is claimed is:

1. A contact plate arrangement for a battery module, comprising:
a first contact plate connected to first terminals of a first parallel group of battery cells (P-Group) and to second terminals of a second P-Group;
a second contact plate that is partially stacked over the first contact plate, the second contact plate connected to first terminals of the second P-Group and to second terminals of a third P-Group; and
a third contact plate that is partially stacked over the second contact plate, the third contact plate connected to first terminals of the third P-Group.

2. The contact plate arrangement of claim 1, wherein the first terminals are negative terminals and the second terminals are positive terminals.

3. The contact plate arrangement of claim 1, wherein the first terminals are positive terminals and the second terminals are negative terminals.

4. The contact plate arrangement of claim 1,
wherein the first contact plate and at least one additional contact plate is arranged as part of a first contact plate layer,
wherein the second contact plate and at least one additional contact plate is arranged as part of a second contact plate layer,
wherein the third contact plate and at least one additional contact plate is arranged as part of a third contact plate layer,
wherein each contact plate in the third contact plate layer is partially stacked over at least one contact plate in the first contact plate layer and/or the second contact plate layer, and
wherein each contact plate in the second contact plate layer is partially stacked over at least one contact plate in the first contact plate layer.

5. The contact plate arrangement of claim 1, further comprising:
a first insulation layer arranged between the first and second contact plates; and
a second insulation layer arranged between the second and third contact plates.

6. The contact plate arrangement of claim 1, wherein the first, second, and third P-Groups each comprise the same number of battery cells.

7. The contact plate arrangement of claim 6, wherein the first, second, and third P-Groups each comprise three battery cells.

8. The contact plate arrangement of claim 1, wherein at least one of the first, second and third contact plates is configured as a single-layer contact plate.

9. The contact plate arrangement of claim 1, wherein at least one of the first, second and third contact plates is configured as a multi-layer contact plate whereby a cell terminal connection layer is partially sandwiched between two solid plate layers.

10. The contact plate arrangement of claim 1, wherein at least one of the first, second and third contact plates comprises steel, aluminum, copper, or any combination thereof.

11. The contact plate arrangement of claim 1, wherein the third contact plate is a negative pole contact plate of the battery module or a positive pole contact plate of the battery module.

12. The contact plate arrangement of claim 1, wherein the third contact plate is further connected to second terminals of a fourth P-Group.

13. The contact plate arrangement of claim 12, further comprising:
a fourth contact plate connected to first terminals of the fourth P-Group and to second terminals of a fifth P-Group, the third contact plate being partially stacked over the fourth contact plate;
a fifth contact plate that is partially stacked over the fourth contact plate, the fifth contact plate connected to first terminals of the fifth P-Group and to second terminals of a sixth P-Group; and
a sixth contact plate that is partially stacked over the fifth contact plate, the sixth contact plate connected to first terminals of the sixth P-Group.

14. The contact plate arrangement of claim 13, wherein the first terminals are negative terminals and the second terminals are positive terminals.

15. The contact plate arrangement of claim 13, wherein the first terminals are positive terminals and the second terminals are negative terminals.

16. The contact plate arrangement of claim 13, wherein the sixth contact plate is a negative pole contact plate of the battery module or a positive pole contact plate of the battery module.

17. The contact plate arrangement of claim 1, further comprising:
another contact plate connected to second terminals of the first P-Group.

18. The contact plate arrangement of claim 17, wherein the another contact plate is a positive pole contact plate of the battery module or a negative pole contact plate of the battery module.
